(19) United States
(12) Patent Application Publication
(10) Pub. No.: US 2011/0077773 A1
(43) Pub. Date: Mar. 31, 2011

(54) ENVIRONMENTALLY-ADAPTIVE SHAPES WITH A MULTI-AGENT SYSTEM

(76) Inventors: Chih-Han Yu, Taichung (TW); Radhika Nagpal, Cambridge, MA (US)

(21) Appl. No.: 12/769,107

(22) Filed: Apr. 28, 2010

Related U.S. Application Data
(63) Continuation of application No. PCT/US08/81759, filed on Oct. 30, 2008.
(60) Provisional application No. 60/983,755, filed on Oct. 30, 2007.

(51) Int. Cl. G05B 19/04

(52) U.S. Cl. 700/253

(57) ABSTRACT

A modular robot having a plurality of agents for performing movements is provided. Each of these agents includes a computation component for performing computations needed in performing selective movements of the modular robot structure. A communication component is coupled to the computation module. The communication component allows each agent to communicate with its immediate physically-connected neighbor. An actuation component performs actuations associated with movements of the modular robot. A sensing component measures positional information that allows the agent to determine its respective environment. Once a defined shape or a desired task has been specified, each of the agents and their respective component coordinate their respective movements until the defined shape is reached.

### PRIORITY INFORMATION

This application claims priority from provisional application Ser. No. 60/983,755 filed Oct. 30, 2007, which is incorporated herein by reference in its entirety.

### BACKGROUND OF THE INVENTION

The invention is related to the field of modular and distributed robots, and in particular to a generalized distributed consensus control framework used by modular robots.

A modular robot is a new class of robots that is composed of many independent modules. Each module can communicate locally with other modules that are physically connected to it. By applying appropriate control, modular robots are capable of changing their configurations to become different structures or shapes, so they are sometimes referred as (self) reconfigurable robots. There are mainly three types of hardware design for modular robots. The first type is the “chain-based” modular robot where modules are normally connected in a chain and perform tasks such as locomotion by controlling their actuators. Another common style is the “lattice-based” modular robot, where overall shape change is achieved by modules changing their local connectivity. More recently, several groups have proposed strut-based modular robot in which shape formation is achieved by modules' self-deformation.

Several groups have demonstrated centralized and decentralized control in modular robots. However, there are only a few that focus on self-adaptation tasks based on sensory feedbacks. In chain-based robots, robot locomotion conforms to the environment via a hand-designed gait table and distributed force feedback. However, there is no theoretical guarantee for the control laws they propose adaptive locomotion strategy for chain-based robots is based on CPG.

In a lattice-based system, distributed algorithms can be used for locomotion over obstacles. One major limitation of lattice-based systems in self-adaptive tasks is that shape change can only be achieved through module movement, which is slow in the hardware implementation.

### SUMMARY OF THE INVENTION

According to one aspect of the invention, there is provided a modular robot having a plurality of agents for performing movements. Each of these agents includes a computation component for performing computations needed in performing selective movements of the modular robot structure. A communication component is coupled to the computation module. The communication component allows each agent to communicate with its immediate physically-connected neighbor. An actuation component performs actuations associated with movements of the modular robot. A sensing component measures positional information that allows the agent to determine its respective environment. Once a defined shape or a desired task has been specified, each of the agents and their respective component coordinate their respective movements until the defined shape is reached.

According to another aspect of the invention, there is provided method of performing movements of a modular robot. The method includes providing a plurality of agents and managing computations associated with each agent needed in performing selective movements of the modular robot. Also, the method includes managing communications between the agents and performing actuations associated with movements of the modular robot. Moreover, the method includes measuring positional information that allows the agent to determine its respective environment and defining a shape so that each of the agents coordinate their respective movements until the defined shape or desired task is reached.

### BRIEF DESCRIPTION OF THE DRAWINGS

FIGS. 1A-1C are schematic diagrams illustrating pressure-adaptive structures formed in accordance with the invention;

FIGS. 2A-2D are schematic diagrams illustrating several different types of shapes that can be achieved within this framework;

FIG. 3 is a schematic diagram illustrating a self-balancing table robot formed in accordance with the invention;

FIGS. 4A-4D are schematic diagrams illustrating the various orientations of a self-balancing table robot formed in accordance with the invention;

FIG. 5 is graph illustrating self-balancing a table robot's response time to repeated environment changes;

FIG. 6A-6D are graphs illustrating a table robot's response time to different initial conditions and various responses of the agents used;

FIG. 7 is a table illustrating the mean and standard deviation for a table robot to reach 10% of error;

FIGS. 8A-8D are schematic diagrams illustrating the algorithm used by a pressure-adaptive structure formed in accordance with the invention;

FIGS. 9A-9D are schematic diagrams illustrating the algorithm used by a gripper formed in accordance with the invention;

FIGS. 10A-10E are schematic diagrams illustrating the algorithm used by a tetrahedral robot formed in accordance with the invention;

FIG. 11 is a graph illustrating pressure-adaptive column with different initial conditions;

FIGS. 12A-12H are schematic diagrams illustrating the tasks performed by a gripper;

FIGS. 13A-3C are graphs illustrating the performance of a gripper used in accordance with the invention; and

FIGS. 14A-14F are schematic diagrams illustrating the tasks performed by a tetrahedral robot.

### DETAILED DESCRIPTION OF THE INVENTION

The invention proposes a generalized distributed consensus control framework. This generalization allows many new application areas in modular robotics by extending such a control scheme in several directions. New types of sensors can be use, e.g., pressure and light sensors. In these cases, a module agent has an indirect relationship between its sensor and actuator. The invention allows a variety of modular robot tasks to be formulated and solved as self-adaptation processes based on environmental feedback, including structure adaptation, sensory adaption, gripper manipulation, and locomotion.

One can use the same underlying distributed control principle to derive control laws for these tasks. The control laws are robust and simple to implement. One can show that the control laws are provably correct: convergence can be guaranteed to the tasks being considered. The proposed control framework is implemented on five different hardware robot prototypes and show that it is robust toward sensing/actuation noise and exogenous perturbations. This framework can potentially be applied to many distributed robotics applications beyond modular robotics.

The robot model and the capabilities assumed in the framework is described. The primary focus is on modular robotic systems in which the whole robot is composed of many independent and autonomous modules. However, this decentralized control framework is applicable to many other distributed robotic systems as long as the assumptions described herein are satisfied.

In the model, each module is an independent agent that has computation, communication, and actuation capabilities. One can refer to an autonomous module as an agent. These agents can be reconfigured into different robotic systems. Agents are assumed have been connected into a fixed configuration and they need to coordinate with each other to complete a desired task. The assumptions are now described that each agent is assumed to satisfy, and one can use three different modular robots (an adaptive column, a modular gripper, and a modular tetrahedral robot) that are built as examples.

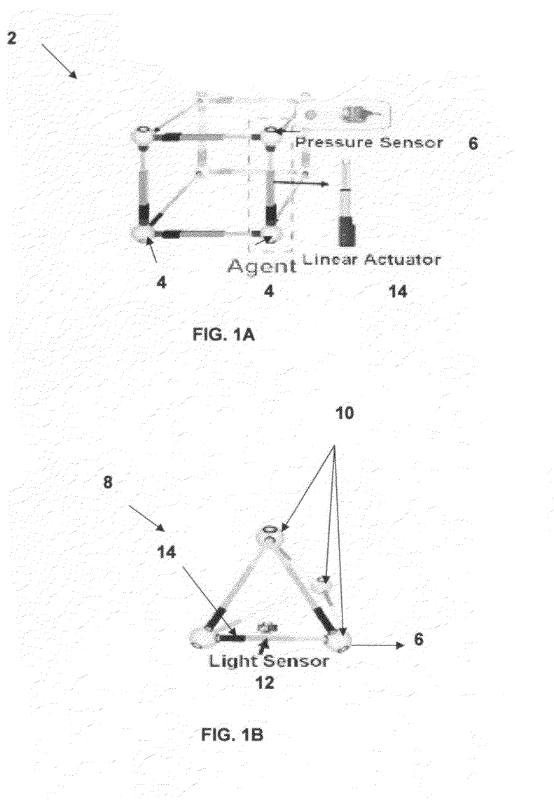

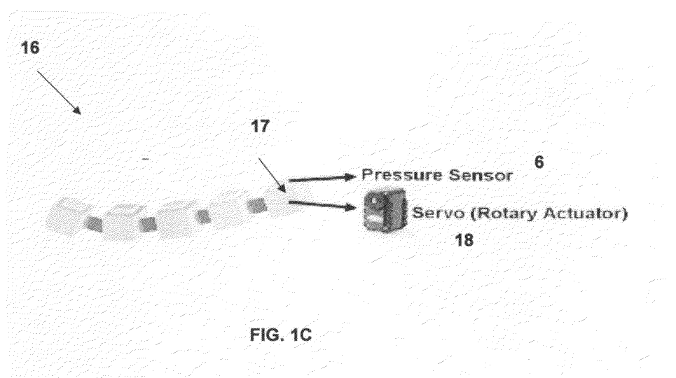

Each agent 4 is equipped with one or more sensors 6 suited to different robotics applications. Sensors 6 are used to measure the current state of the agent 4. In the pressure-adaptive structure 2 as shown in FIG. 1A, a pressure sensor 6 is mounted on each agent 2. In the tetrahedral robot 8 as shown in FIG. 1B, agents 10 are supplied with light sensors 12 positioned on actuator 14 to provide additional environmental triggers.

Each agent is equipped with an actuator. Several types of actuators are considered in the framework. In the pressure-adaptive structure 2 and tetrahedral robots 8, each agent 2, 10 is equipped with a linear actuator 14. In the modular grippe 16r, a rotary servo 18 is mounted on each agent 17 as shown in FIG. 1C.

Moreover, each agent is capable of performing simple computations such as addition and multiplication. Each agent is able to communicate with its immediate neighbors that are physically connected to it. Most of the current modular robots have these stated capabilities.

The task is described as inter-agent sensor constraints. An agent's task is complete when it has satisfied sensory state constraints between it and its neighbors. A consensus is formed when all agents have satisfied their constraints with their neighbors. In the framework, a task can be composed of one or more processes for reaching consensus.

A brief review of the standard distributed consensus algorithm is provided. A more general form of the algorithm and sufficient conditions is presented for agents to reach consensus. This generalized framework allows us to extend the control law to a wide range of applications.

Distributed consensus is a process by which a group of networked agents come to a state of agreement by communicating only with neighbors. At each time step, each agent updates its new state according to the difference between its own state and its neighbors' states. This process can be formally written as:

$${x}_{i} ( t + 1 ) = {x}_{i} ( t ) + α {\sum }_{{α}_{j} ∈ {N}_{i}} {x}_{j} ( t ) - {x}_{i} ( t ) \qquad Eq . 1$$

where a indicates agent i, and x (t) and x (t+1) are actuation states of agent i at time step t and t+1, respectively. Nⱼ indicates the set of all one-hop neighbors of agent i is a small constant, and is sometimes called damping factor. There are two main assumptions buried in Eq. 1: First, each agent is capable of directly observing or computing its state and its neighbors' states. Second, each agent is capable of freely driving itself to a new state x (t+1).

In many cases, the mapping between sensor space and agent's actuation state is not precisely known. For example, in the modular gripper 16, as shown in FIG. 1C, the mapping between the actuator's rotational angle and agent sensor value cannot be directly computed. One can propose a more general form of the agent update equation:

$${x}_{i} ( t + 1 ) = {x}_{i} ( t ) + α \cdot {\sum }_{{α}_{j} ∈ {N}_{i}} g ( {θ}_{i} , {θ}_{j} ) . \qquad Eq . 2$$

where θᵢ is agent αᵢ's sensor reading and θⱼ indicates sensor reading of αⱼ's neighbor, a3. g(θᵢ,θⱼ) is a sensory feedback function that agent a computes based on θᵢ and θⱼ. One can denote T(•) as a function that maps the agent's actuation changes to sensor changes. Also, one can show that g(•) can be any function satisfying the following conditions:

g(θᵢ,θⱼ)=0 [symbol] θᵢ=ⱼ Eq. 3

sign(T(g(θᵢ,θⱼ)))=sign(θⱼ−θᵢ) Eq. 4

g(−θᵢ,−θⱼ)=−g(θᵢ,θⱼ) Eq. 5

Intuitively, Eq. 3 means that g only “thinks” the system is solved when it actually is; Eq. 4 means that when not solved, each sensory feedback g at least points the agent in the correct direction to satisfy the local constraint with a neighboring agent; and Eq. 5 means that g is anti-symmetric.

In addition, one needs to ensure that g/xⱼ(t)−xᵢ(t)−Δ_{i,j}* holds for all aᵢ and for all t where Δ_{i,j}* is the desired state difference between agents that achieves θⱼ=θᵢ. This will ensure agents' states from fluctuation while reaching the consensus state, and it is usually done by selecting an appropriate α constant and choosing g as a function that is proportional to distance from the desired state.

This formulation is capable of being applied to a large class of distributed control tasks provided that one can create local agent rules that satisfy the conditions. In the next section, three different generalizations and their applications are described.

When solving modular robot tasks, there are still two main challenges one needs to address to apply this framework. First, one needs to represent a new task in terms of inter-agent sensor constraints or consensus. Second, a design is needed to have an appropriate sensor feedback function g and prove that the conditions outlined in Eqs. 3-5 are satisfied.

Solutions are provided to these challenges using six different example applications: (A) a self-balancing table that autonomously adapts to uneven terrain; (B) a terrain-adaptive bridge that always maintains bridge surface level irrespective of underlying terrain; (C a self-adaptive 3D Relief Display that can render a variety of shapes on arbitrary terrains (D) a pressure-adaptive column in which case each agent's sensor and actuator has an indirect relationship; (E) a modular gripper in which case each agent's actuator has a long range effect; (F) a modular tetrahedral robot which extends the agents' task space from forming a single consensus to a sequence of consensuses.

The inventive algorithm for shape formation has several important features: (1) The algorithm involves simple, local behavior by each agent, which scales as one can add more supporting groups to the flexible sheet; (2) the algorithm is guaranteed to converge to the target shape; (3) if the terrain changes, the robot automatically adjusts to maintain the desired shape.

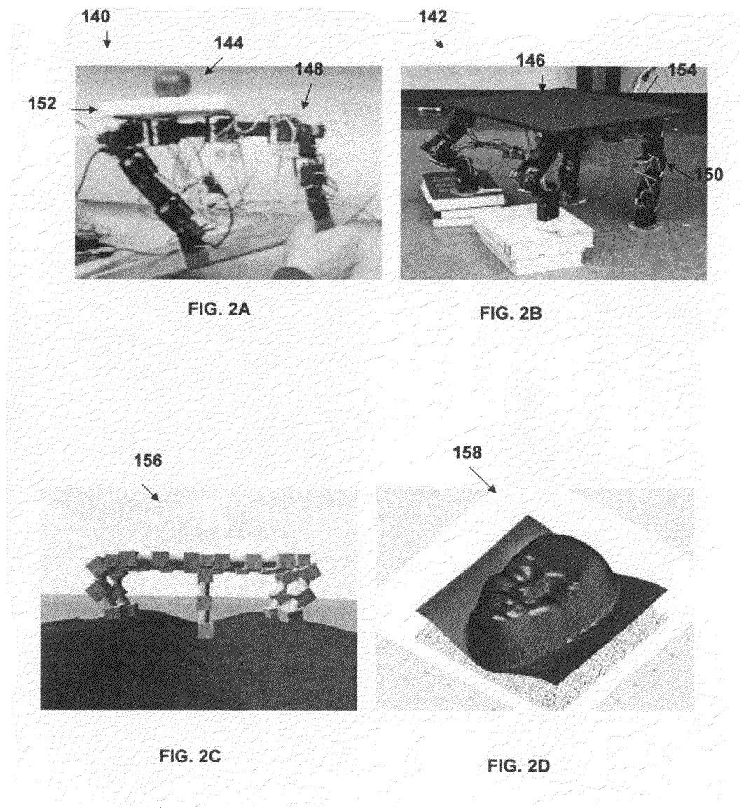

These features lead to many potential applications. FIGS. 2A-2B show hardware prototypes 140, 142 of the self-balancing chain and table, respectively. In this demonstration, the top portions 144, 146 of the chain 148, 150 and table 152, 154 remain level regardless of terrain conditions. This could be useful in many circumstances, for example, stabilizing instruments on a boat.

In the inventive framework, one can achieve a modular robotic bridge that can adapt to different terrains. One can construct a terrain-adaptive bridge with Open Dynamics Engine 156, as shown in FIG. 2C. When it is placed on an unknown rough terrain, the robot 156 can automatically form a flat surface or a smooth incline. Even if the terrain changes over time, the modular robot 156 adapts to maintain a level surface. Robot locomotion over rough terrains has been a challenging problem. A modular robotic bridge can automatically form a smooth roadway over the rough terrain for the other robots.

3D Relief Display is an application where a modular robot forms arbitrary shapes as a novel form of 3D media and visualization. A proposed flexible surface 158 can act as a “relief” display, since the distributed algorithm can easily achieve complex shapes, as shown in FIG. 2D. Applications in this domain require efficient transformation from one shape to another. In addition, such display device is able to adapt to different environments and achieve desired shape. The distributed property of the inventive algorithm makes this high dimensional control problem scalable and allows efficient shape transformation.

Note that this approach can be used in combination with traditional rearrangement reconfiguration, e.g. a modular robot can locomote quickly on smooth terrain using a track-like configuration and then configure to form a bridge over rough terrain. One can also expect that this distributed control approach can be extended to dynamic shape descriptions and other types of sensing (e.g. pressure), opening up many application possibilities which is described hereinafter.

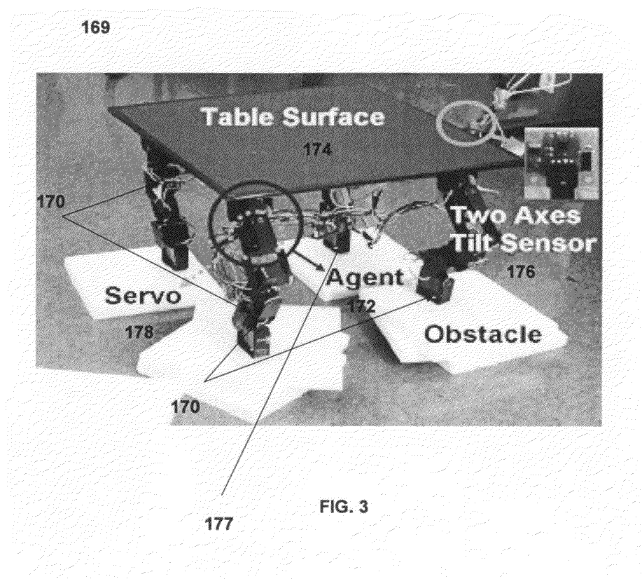

The invention can be used to design and implement a self-balancing table robot 169 to test how well the approach works in real world scenarios, as shown in FIG. 3. The robot 169 is composed of four supporting groups (legs) 170, and each composed of three agents 172. Since the table surface 174 is designed to be a flat rigid surface (43 cm×43 cm square) and includes sensors 176, 177 where the tilt sensor 177 is mounted in the middle, as shown in FIG. 3. The sensors 176, 177 form surface group modules and are connected on the table surface 174. The sensors 176, 177 are used representing information about the tilt of the table surface 174. In addition to its original role, the top agent 172 of each supporting group 178 is also programmed to be a pivot. The supporting groups 170 and surface group modules 177, 176 are actuated simultaneously to achieve a shape change. The selective number of the surface group modules 176, 177 can provide information to their neighboring agents 176, 177, each of said neighboring agents 176, 177 collect the information and computes a feedback. The neighboring agents 176, 177 provide the feedback to a selective number supporting groups 170, each agent 172 of the selective supporting groups 170 can uses the feedback information to perform actuation.

Each agent 172 controls a Hitec standard servo 178 which can perform a rotation of 90° in either a clockwise or counterclockwise direction. A two-axis (x and y) tilt sensor 176 is mounted on the table surface 174. Each of the pivots can receive from this sensor 176, instead of having their own tilt sensors. Both sensors 176, 177 serve to act as agents for the surface group modules 176, 177.

For simplicity of implementation, the distributed shape formation algorithm is run on a laptop computer (2 GHZ CPU) that simulates purely distributed control. Although the distributed control is simulated, the hardware implements the sensing and distributed actuation so that one can directly test the algorithm in the face of real-world noise. After each agent computes the new angle of its servo, the control signal is sent to the hardware robot via serial port. It takes approximately 50 milliseconds for all agents to finish one iteration. This hardware prototype robot is used by the invention.

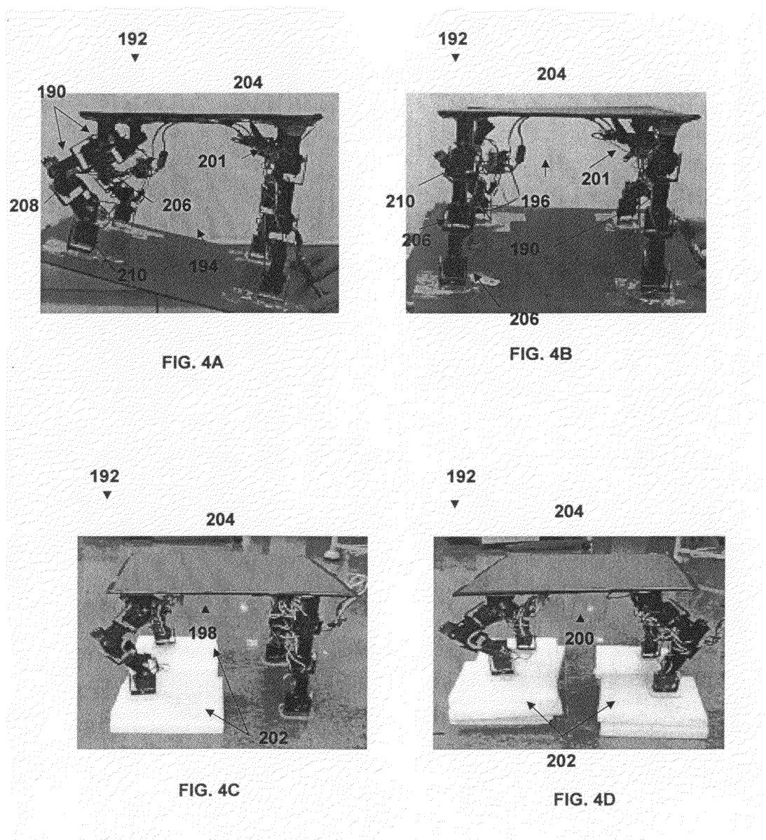

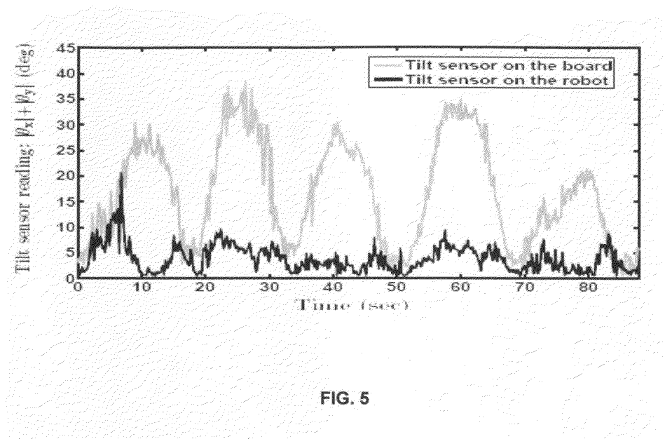

In a first experiment, it is examined how quickly and accurately the robot 192 responds to consistent, rapid environmental changes. In this experiment, the robot's 192 four supporting groups 190 are fixed to a rigid board. One can repeatedly change the orientation 194-200 of the board 204 to examine the robot's 192 response, as shown in FIGS. 4A-4D. Each supporting group includes a top 206, middle 208, and bottom agent 210. One additional tilt sensor 201 is mounted on the board to record environmental changes. This sensor 201 does not supply input to the robot. Empirically, the sensors 200 being used are somewhat noisy, especially under high speed motion e.g. first five seconds of FIG. 5.

Agents 206-210 are programmed to maintain a surface level surface; i.e. tilt angles in x axis and y axis, θₓ and θ_{y}, equal to zero at all times. Therefore, |θₓ|+|θ_{y}| is an error measure of how far the table surface is from a level state.

FIG. 5 shows the results of the experiment. One can see that even when the tilt angle of the floor is changed by 30°-40° over a few seconds, the table is able to quickly respond and keep the surface level. The table never tilts more than 5°-8° after the initial correction.

In a second experiment, it is examined how the robot responds to different rough terrains. As shown in FIGS. 4C-4D, the robot's four supporting groups 190 are placed on four obstacles 202 of different heights. Each foot placement position was placed with several bricks (a brick's thickness is 2.5 cm). Through different combinations of bricks, one can generate different rough terrains.

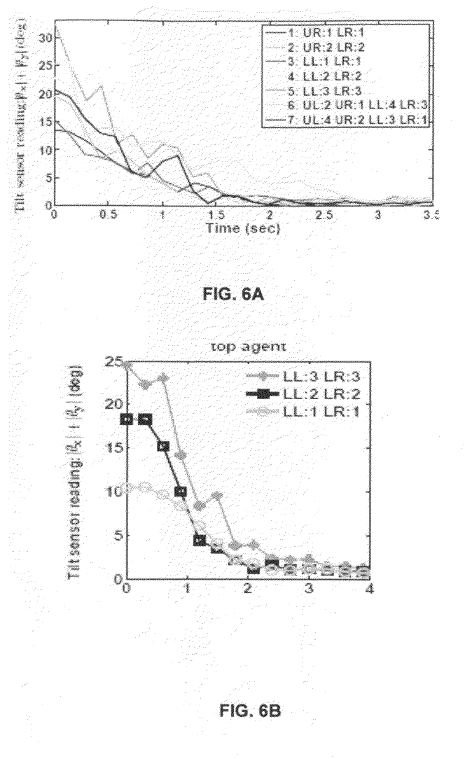

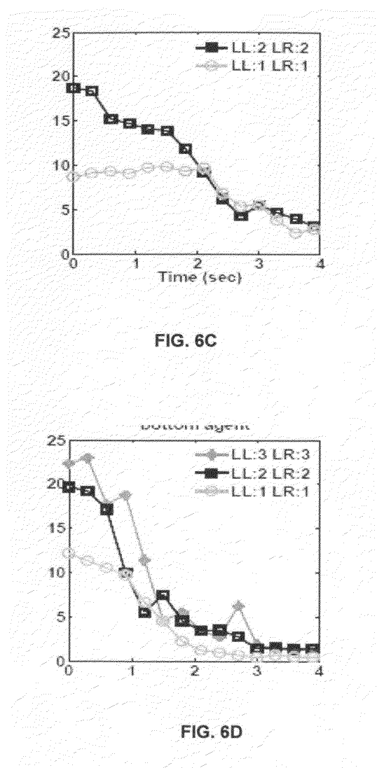

FIG. 6A-6D shows the robot's response time to achieving levelness under different terrains. In the first five experiments, two legs on one side are lifted. In the last two experiments, the robot's four legs are lifted simulating fully irregular terrain scenarios. As shown in the figure, the robot is capable of achieving levelness (|θₓ|+|θ_{y}|<3°) within 2 seconds (−40 iterations) in most of the cases. This is the only case which takes the robot >2 seconds to achieve levelness, since its setup requires all pivot to collaborate with its neighbors rigorously.

Note as the table surface is a rigid object and cannot be stretched, the horizontal between two pivots might change in the process. Nevertheless, the algorithm still behaves correctly even if one can treat the horizontal distance as a fixed constant over the process.

Robustness experiments are performed by observing the robot's reaction when one of the agents fails. It was tested under different task difficulties and in different positions in the group. Two situations were tested which an agent fails to respond: (1) the agent's servo is disabled and becomes a passive link, so it freely takes on any angle with no resistance to movement; and (2) the agent's servo remains stuck at the zero degree position at all times. It is discovered that the first case does not affect the effectiveness of the algorithm, while the second case affects a few scenarios. It implicitly means the algorithm is robust to hardware failure of the first case.

FIG. 6A shows the robot's response time to different initial conditions. In several experiments, it achieves |θₓ|+|θ_{y}|<3°, within 2 seconds (or 30 iterations). FIG. 6B shows robustness test results when one of the agents does not respond. FIGS. 6B-6D are scenarios when top, middle, and bottom agents do not respond respectively. It is most critical when the middle agent fails.

FIGS. 6B-6D show the robot's responding time to achieve levelness while different agents do not participate in the task. One side of the robot lifts to 1 to 3 bricks high respectively. At each height, one of the three agents in the supporting groups that needs to be compressed is disabled (top, middle, or bottom). This process was repeated four times and FIGS. 6B-6D show the average of robot's tilt angle across time. One can see from FIG. 6C that the middle agent's failure is more critical than top, as shown in FIG. 6B, and bottom agents, as shown in FIG. 6D. When the middle agent fails, the robot generally falls over in the third experiment (3 bricks). When the obstacle is one or two bricks high, it achieves <4° of tilt angle in 4 seconds.

It is observed that when the middle agent fails, it leads to a more unstable state of the robot. This is primarily because it is responsible for two times more rotation than either top or bottom module. On possible solution is to have more modules in each leg which allows a greater flexibility to compensate for individual failure, as well as increase the range over which the leg can compress and uncompress.

The distributed algorithm can provably form arbitrary shapes, and the pivot actions remain local even when the number of surface groups increases. Here one can evaluate the scalability of our system by observing how convergence time is affected by a large number of surface groups and different shape complexities. One can implement a simulation of a 64×64 flexible sheet in MATLAB, which includes 4096 pivots/supporting legs (16384 agents) for tasks of forming a pre-defined 3D shape. One can assume surface groups are formed by elastic materials. In simulation, one can add Gaussian noise to both servo actuation and sensor readings.

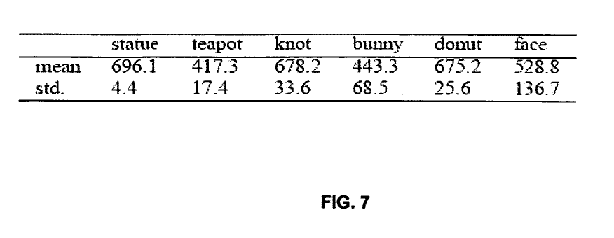

The robot is programmed to render six 3D models: a statue, teapot, knot, bunny, donut, and face. 3D depth information is used to transform these models into tilt angles for shape specification. The simulation starts by placing the robot on a randomly generated terrain. One can define the initial state as 100% error to the desired shape and 0% error when the desired shape is perfectly achieved. Table I shows the mean and standard deviation for the robot to reach 10% of error. In our previous experiments, the self-balancing table (12 agents) achieves 10% of error around 40 iterations. One can see from FIG. 7 that the algorithm scales well with the number of agents: when the number of agents increases from 12 to 16384 and the shapes become much more complex, the number of iterations required increases only between 10 and 15 times.

The invention presents a decentralized control framework that allows a chain-style modular robot to achieve various environmentally-adaptive shapes. The control algorithm is shown to provably converge: it leads the robot to form the desired shapes regardless of its initial conditions and environmental changes. Through the experiments discussed above, one can demonstrate that the proposed algorithm is effective in real world applications.

Another potential application for modular robotics is a reconfigurable structure: a structure that can reconfigure itself to achieve functional requirements irrespective of external environment changes. Examples include forming the supporting structure for a building that absorbs uniform force, and a modular seat back that adapts to apply uniform pressure on the user. Motivated by this application area, one can construct a pressure-adaptive column with a modular robot 20 as shown in FIGS. 2A-2D.

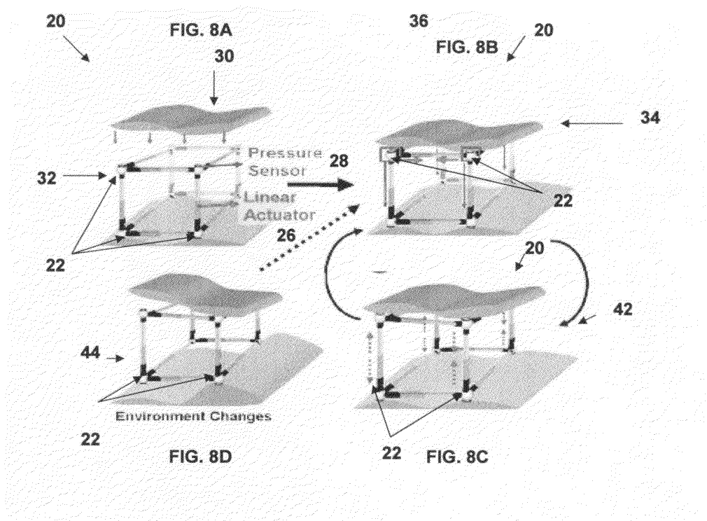

As shown in FIG. 8A, each agent 22 is equipped with a linear actuator 26 whose length can be precisely controlled and a pressure sensor 28 that can sense the force applied on each agent 22. The agents 22 are programmed to achieve a state where each agent 22 absorbs equal force when an unknown object or structure 30 is placed on it.

The algorithmic overview of the self-adapting process is shown in FIGS. 8A-8D. FIG. 8A shows a step 32 illustrating an unknown object 30 being placed on the robot 20. FIG. 8B shows a step 34 illustrating each agent starts exchanging current pressure sensor feedback with its neighbors. FIG. 8C shows a step 42 illustrating each agent 22 computing its actuator's new parameters based on the sensor feedback that it receives from all its neighbors. Each agent 22 iterates between the steps shown in FIGS. 8B and 8C until the desired state has been reached: θᵢ−θⱼpε, where ε is a small. When the environment starts changing again, the robot 20 performs step 44 and automatically goes back to step 34 of FIG. 8B as shown in FIG. 8D.

In step 42, each agent 22 runs a local control law to change the length of its linear actuator 26 based on sensory feedback from its neighbors. This control law can be written as:

$${x}_{i} ( t + 1 ) = {x}_{i} ( t ) + α \cdot {\sum }_{{α}_{j} ∈ {N}_{i}} ( {θ}_{j} - {θ}_{i} ) \qquad Eq . 6$$

Here, the feedback function g is simply g(θᵢ,θⱼ)=θⱼ−θᵢ. g satisfies conditions Eq. 3-Eq. 5, since: (1) when θⱼ=θᵢ, g(θᵢ,θⱼ)=θⱼ−θᵢ=0, (2) when sensory θᵢ is smaller than θⱼ, g(θᵢ,θⱼ)>0 such that agent a increases its length to increase its pressure state θᵢ. Therefore, T(g(θᵢ,θⱼ)) is moving in the same direction as θⱼ−θᵢ, (3) g function is anti-symmetric. Therefore, the control law (Eq. 6) will allow the robot to converge to the desired state.

Another application of the invention is modeling of a modular gripper. The gripper is capable of reconfiguring itself to grasp an object using distributed sensing and actuation. The control law design follows a similar procedure as in the described above for Eq. 6. However, the analysis of the convergence property is somewhat different due to the fact that each agent's actuation affects more than its own sensor state.

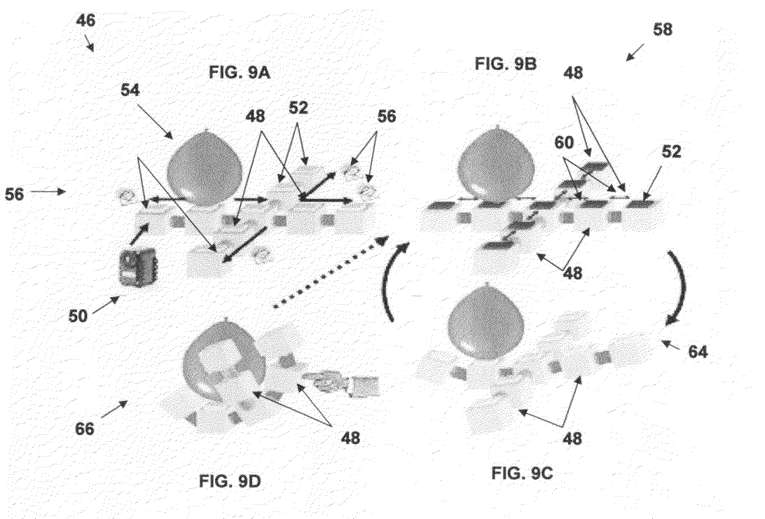

As shown in FIGS. 9A-9D, a modular gripper 46 is composed of a chain of modular agents 48, where each agent 48 is equipped with a rotary servo 50 and a pressure sensor 52. The goal of the agents 48 is to grasp a convex object 54, for example, a balloon, such that all of the agents 48 apply equal pressure θₚ(θₘᵢₙ≦θₚ≦ₘₐₓ).

The illustration of the algorithmic procedure is shown as FIGS. 3A-3D. FIG. 9A shows a step 56 wherein one of the agents 48 starts sensing an object 54. When the sensor reading is in between θₘᵢₙ and θₘₐₓ, it starts sending messages to neighboring agents 48. Upon receiving a message 56, each agent 48 propagates the message 56 and its ID to neighboring agents 48, as shown in FIG. 9A. One can denote Rᵢ as the agent ID from which agent αᵢ receives the message and Sᵢ as the ID of the agent to which it sends the message. FIG. 9B shows a step 58 wherein each agent 48 starts sending its pressure sensor reading 60 to its neighbors. Note this sensory reading message 60 is passed only between an agent 48 and its immediate neighbors.

FIG. 9C shows a step 64 where each agent 48 computes its new actuation state based on the sensor readings that it receives from its neighbors. The control law run by each agent 48 is:

xᵢ(t+1)=xᵢ(t)+(θ_{R}_{ᵢ}−θᵢ) Eq. 7

Agents 48 iterate between step 58 and step 64 until all agents 48 have reached the desired state, as shown in step 66 of FIG. 9D. When the robot 46 is perturbed by exogenous force, it goes back to step 58.

The control law one can show in Eq. 7 satisfies condition 1, since sensory feedback g(•)=θ_{R}_{ᵢ}−θᵢ=0 only when agent αᵢ's sensor reading equals to its neighbor α_{R}_{ᵢ}. In addition, g is also anti-symmetric. However, it is nontrivial to evaluate whether the control law satisfies condition 2. This is primarily due to the fact that all agents are connected together in a chain and changing an agent's actuation parameter can potentially change more than its own sensor state.

Most of the controllers designed for grasping tasks have used a centralized architecture. The decentralized and modular robot approach that is proposed here allows the whole system to adapt to local perturbations more efficiently. In addition, given any initial contacting module, the gripper is able to form a grasping configuration that conforms to the shape of the object. This control scheme is also applicable to different kinds of gripper configurations.

A single consensus state between agents has been presented. However, one can show how agents can achieve more complicated tasks by forming a sequence of consensus states. A modular tetrahedral robot is presented that is capable of performing locomotion towards a light source with a sequence of such tasks. This approach can be potentially applied to many other modular robot locomotion tasks.

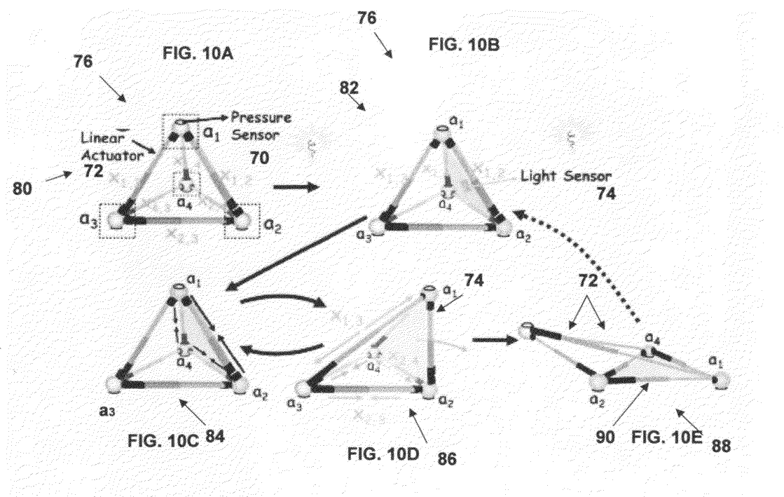

As shown in FIG. 10A, an agent a₁, a₂, a₃ is equipped with a pressure sensor 70 and is capable of controlling actuators 72 that are connected to it. One can denote x_{i,j} as the linear actuator mounted between agent aᵢ and aⱼ. In the example in FIGS. 10A-10D, agent a₁ can control actuators x_{1,2}, x_{1,3}, and x_{1,4}. In addition, a light sensor 74 is mounted on each surface of the tetrahedron 76 as shown in FIG. 10B, and agents a₁, a₂, a₃ on the surface can access the sensor reading. At each locomotion step, a subset of agents a₁-a₄ is selected to form consensus by the light trigger. The selected agents a₁-a₄ perform actuation to achieve nearly equal pressure readings.

The detailed steps are as follows, FIG. 10A shows a step 80 were each agent a₁-a₄ starts passing messages to its neighbors, allowing it to identify its neighboring agents and the linear actuators 72 between them. FIG. 10B shows a step 82 wherein the surface that is closest to the light source 74 is triggered. One can denote the subset of agents on the triggered surface as Ω. In this example of FIGS. 10A-10D, Ω={a₁, a₂, a₄}. FIG. 10C shows a step 84 where the activated agents a₁, a₂, a₄ start sending pressure readings to their other activated neighbors. FIG. 10D shows a step 86 where linear actuators 72 that are on the triggered surface are denoted as surface actuators, and those attached to the triggered surface are denoted as supporting actuators; for example, agent a₁ in FIGS. 10A-10D, has surface actuators x_{1,2} x_{1,4} and supporting actuator x_{1,3}. In step 84, each agent a₁, a₂, a₄ actuates the supporting linear actuator (the linear actuator that it is connected to but not on the triggered surface) by running the following control law:

$${x}_{ik} ( t + 1 ) = {x}_{ik} ( t ) + {\sum }_{{α}_{j} ∈ {N}_{i} ⋂ {α}_{j} ∈ Ω} ( {θ}_{j} - {θ}_{i} ) \qquad EQ . 8$$

where xᵢₖ is aᵢ's supporting actuator. This control law will allow the activated surface to lean forward until the tetrahedron rolls over to put all three activated agents in contact with the ground. In FIGS. 10A-10D, this is achieved with x_{2,3} and x_{4,3}'s contraction and x_{1,3}'s expansion. In the hardware implementation, all actuators are fully contracted in the default state, so x_{2,3} and x_{4,3} are not able to further contract. Alternatively, one can program agents that have ground contact (a₂ and a₄) to actuate the surface actuator between them (x_{2,4}). Agents iterate between steps 84 and 86 until they converge to the consensus state.

The consensus state is formed when all activated agents have ground contact and ∥θⱼ−θᵢ∥≦ε for all agents ai and their neighbors aⱼ. After agents have achieved consensus, they reset to the default configuration (step 86), and a new surface is triggered, as shown in FIG. 10E.

The verification of sufficient conditions for reaching consensus with the control law Eq. 8 is similar to that of Eq. 6. The generalization of a single consensus formation to a sequence of consensuses allows this framework to extend from solving static shape/structure adaptations to dynamic tasks such as locomotion. Utilizing agents' sensor consensus provides a way for modular robots to adapt to different environmental conditions. In the tetrahedral robot example, the cycle time of locomotion is determined by the pressure states of the agents. When the environmental conditions allow agents to reach consensus state sooner, for example, when the robot is on a steeper slope, the locomotion cycle time will adapt to become shorter.

There are many potential applications that can be generalized from this framework. Here illustrate some of them are illustrated: (1) Light-adaptive modular panel: One can change the pressure sensors that are mounted on the robot to light sensors. Each agent is programmed to achieve the same light absorption as its neighbors. A similar concept can be applied in many environmental sensory adaptation tasks. (2) Adaptive prosthetic structure: Existing prosthetic devices for children require manual reconfiguration to adapt to limb growth. If force (pressure) sensors are mounted on the device, it is possible to construct a self-reconfigurable prosthetic device. (3) A similar concept can be applied to a support structure for plants. The structure is capable of self-adaptation based on the growth of the plant and lighting conditions. (4) In the dynamic task domain, robotic systems that locomote by shape/structure deformation can potentially apply our framework for locomotion tasks, for example, an amoebic modular robot and a cubic modular robot.

The experimental results of applying this framework in three different real robots are presented. The results show that our decentralized control approach is able to cope with real world sensing and actuation noise to achieve self-adaptation tasks. In the pressure-adaptive column experiments, one can show that agents are capable of converging to an equal pressure state irrespective of different initializations when an unknown object is placed on it. In the modular gripper experiments, it is shown that the control law is capable of leading agents to grasp around a balloon while applying equal pressure on it. Furthermore, agents are capable of achieving the desired state regardless of initial contact locations. They can also maintain the desired state when facing exogenous perturbations. In the modular tetrahedral robot experiments, it is show that the robot is capable of moving toward a light source through a sequence of consensus formation processes.

In this experiment, one can examine the control law's convergence property with different initial conditions. Each agent is equipped with a pressure sensor (force sensing resistor) with sensory readings ranging from 0 to 900. Agents are programmed to achieve equal pressure with their neighbors. The weight of the unknown object is roughly 1.5 pound. The robot starts in three different configurations, such that the number of initial contacting agents is different, ranging from one to three.

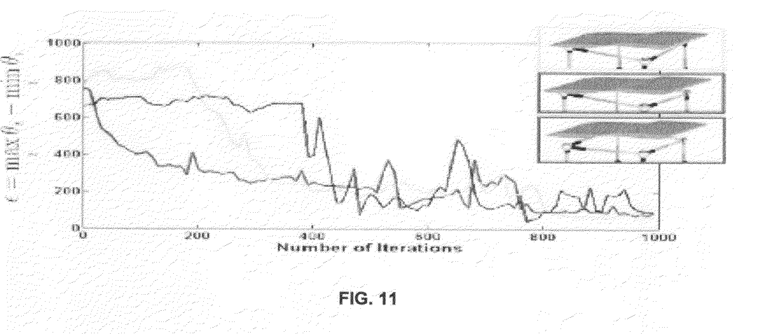

One can define ε=maxᵢθᵢ−minᵢθᵢ, the difference between maximal and minimal sensory reading among agents, as a measure of distance from reaching consensus. One can see from FIG. 11 that ε decreases from 800 to around 100 after 1000 iterations (10 sec. in real time) in all three cases. The sensor used is very noisy and sensitive to slight perturbations of the linear actuators. Therefore, one can set the a Eq. 6 to be a very small constant to avoid the column from being over-sensitive to perturbations. This naturally leads to a longer convergence time. The larger fluctuations in the curve are primarily due to the object significantly shifted its center of mass when more agents contact it.

An empirical evaluation is presented of this control framework when applied to a modular gripper. Agents are programmed to apply equal pressure on a balloon. One can test Eq. 7's convergence properties under different initial conditions and different numbers of agents. One can also assess its adaptability towards repetitive perturbations.

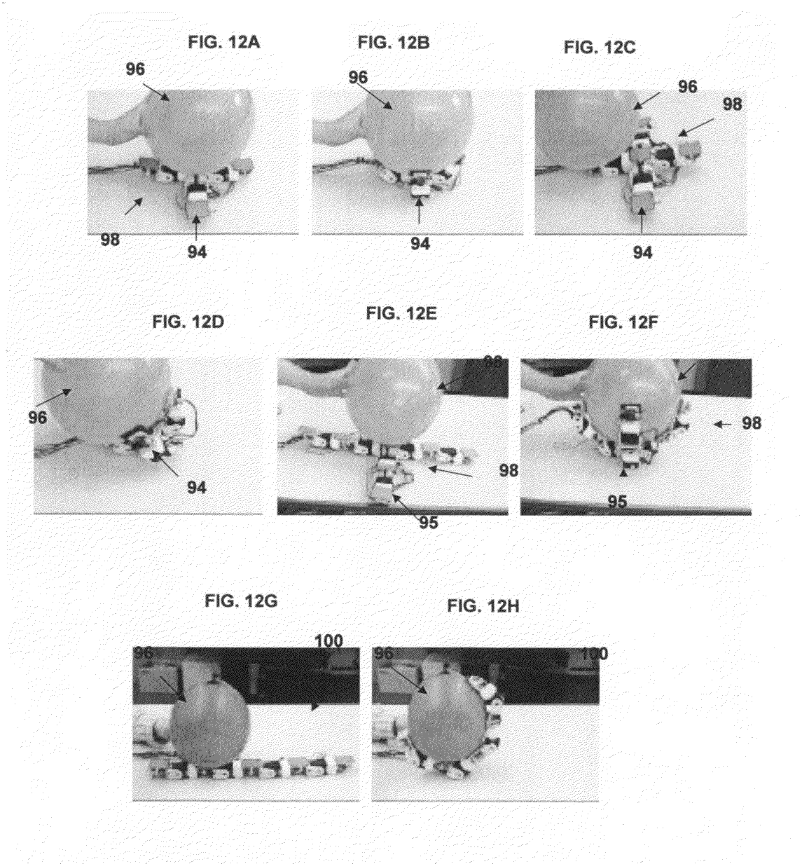

The agents 94 are connected to form a “cross” configuration as shown in FIGS. 6A-6H. Different agents 94 start to touch the balloon 96 to examine the system's behavior under different initial conditions. FIG. 12A-12H show a sequence of robot 98 configurations while grasping the object 96. FIGS. 12A-12D show different initial conditions for the grasping task. The robot 98 is capable of completing the task irrespective of initial conditions. FIGS. 12E-12F shows a scalability experiment. More modules 95 are added to the robot. Empirically, the robot scales successfully to the number of module agents 95. FIGS. 12G-12H show the robot performing the grasping task with a different gripper configuration 100.

One can use k to denote the first activated (contacted) agent's index. One can denote θᵢ(t) as the pressure sensor reading of agent i at time t. After the first contact between the object and the robot, the object is held in place. This will lead all other agents to approach agent aₖ's sensor reading θₖ (t) while reaching the consensus state. Therefore, one can define the percentage from achieving the task, ε, as a ratio of the current distance for all agents to reach the first contacted agent's sensor reading θₖ(t) to the initial distance. This can be formally written as:

ε=Σᵢ∥θᵢ(t)−θₖ(t)∥/Σᵢ∥θᵢ(0)−θₖ(0)∥.

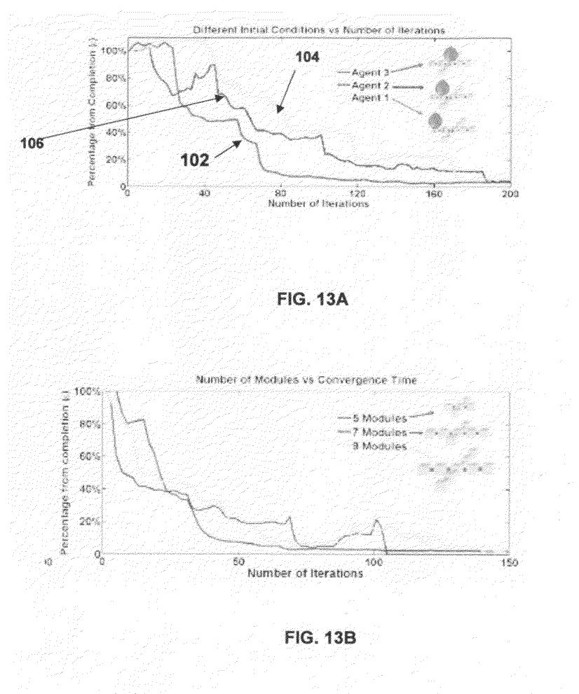

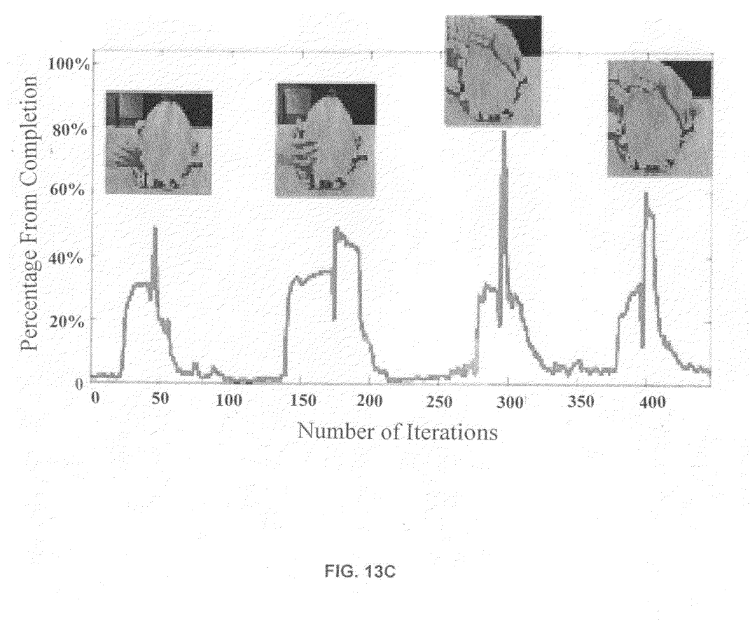

FIG. 13A shows ε's value changing over time. One can see that the agents are capable of converging to 3% from completing the task after 180 iterations, regardless of initial conditions. From this figure, one can also see that there is a correlation between the position of the first activated agent and the convergence time. The curve 102 shows the case when the middle agent is first activated. The maximum communication hop between it and all other agents is two. In this case, agents achieve faster convergence as compared to the case where the maximal hop is three and four respectively, curves 104 and 106.

One can further evaluate the algorithm's scalability towards the number of agents. As shown in FIG. 13B, the number of agents is increased from 5 to 9. From the FIG. 7B, there is no significant increase in convergence time when there is an increase in the number of agents. ε converges to less than 3% after 150 iterations in all three cases. However, one can see that the convergence time is slightly shorter in the 5-agent case in which the diameter of the agent network is only one (in contrast to two in the other cases). This coincides with the previous theoretical result that decreasing the diameter of the agent network can increase convergence speed.

After all agents achieve the desired state, one can start applying an external force on the gripper. FIG. 13C shows g vs time as the gripper encounters four different perturbations. One can see that E decreases to less than 3% after 50-70 iterations in each case. This shows that our decentralize control law can efficiently lead agents recover from exogenous perturbations. The gripper achieves faster adaptation than the pressure-adaptive column is due to: (1) Each agent's actuation has a long range effect, an agent is likely to assist more than its neighbors in the process. (2) The rotary servos used here has better precision than the linear actuators.

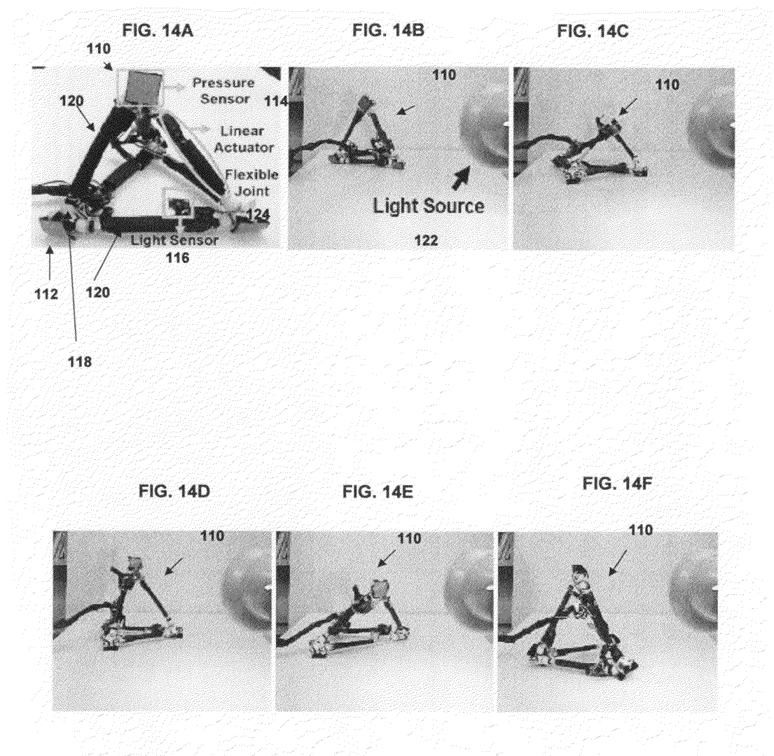

The sequential consensus formation process as described herein is implemented on a tetrahedral robot 110. As shown in FIG. 14A, each agent 112 is equipped with a pressure sensor 114, and each surface 118 has a light sensor 116. The linear actuators 120 are mounted between agents 112, and the actuators' maximal speed is 2.3 cm/sec. One can also create flexible joints 124 on the connecting points between linear actuators 120 and agents 112 to allow deformation of the tetrahedron 110. The height of the tetrahedron 110 is: 20 cm. FIGS. 14B-14F show a sequence of the robot's 110 locomotion actions. Due to mechanical restrictions, one can place the robot on a slope of roughly 10 degrees. This allows the robot to roll over more easily.

As shown in FIGS. 14A-14F, agents 112 on the surface that is closest to the light source 122 are activated in each cycle. The average locomotion cycle time is 5 sec, and the robot 110 is capable of moving towards the light source at a speed of 10 cm/sec.

The invention presents a generalized distributed consensus framework for self-adaptation tasks in modular robotics. Three example applications in hardware are presented using this framework, including (1) a pressure-adaptive column; (2) an adaptive modular gripper; (3) a modular tetrahedral robot. The proposed control laws are provably correct and robust toward different initial conditions and constant perturbations. These applications represent a small set of what is achievable within this framework.

Although the present invention has been shown and described with respect to several preferred embodiments thereof, various changes, omissions and additions to the form and detail thereof, may be made therein, without departing from the spirit and scope of the invention.

What is claimed is:

1. A modular robot having a plurality of agents for performing movements, each of said agents comprising:
a computation component for performing computations needed in performing selective movements of said modular robot structure;
a communication component that is coupled to said computation module, said communication component allows each agent to communicate with its immediate physically-connected neighbor;
an actuation component for performing actuations associated with movements of said modular robot; and
a sensing component for measuring positional information that allows said agent to determine its respective environment, wherein
once a defined shape or task has been specified each of said agents and their respective component coordinate their respective movements until said defined shape or desired sensory state is reached.

2. The modular robot of claim 1, wherein said computation component comprises a microcontroller.

3. The modular robot of claim 1, wherein said actuation component comprises a servo or motor structure.

4. The modular robot of claim 1, wherein said agents are connected to form a flexible surface, said agents are capable of changing the configuration of the surface via actuation.

5. The modular robot of claim 1, wherein each of said agents has a unique identity.

6. The modular robot of claim 1, wherein said sensing component comprises a pressure sensor or tilt sensor.

7. The modular robot of claim 1, wherein each of surface groups is specified with a sensory state respective to a desired shape.

8. The modular robot of claim 4, wherein each agent coordinates with other agents to perform simultaneous actuation to achieve a desired task or shape change.

9. The modular robot of claim 4, wherein each agent provides sensory information to their neighboring agents, each of said agents collect the information and computes a feedback.

10. The modular robot of claim 9, wherein each agent utilizes said feedback to perform actuation, the direction of actuation is toward the direction of achieving a desired state with each neighbor.

11. A method of performing movements of a modular robot comprising:
providing a plurality of agents;
managing computations associated with each agent needed in performing selective movements of said modular robot;
managing communications between said agents;
performing actuations associated with movements of said modular robot;
measuring positional information that allows said agent to determine its respective environment; and
defining a shape or task so that each of said agents coordinate their respective movements until said defined shape or task is reached.

12. The method of claim 11, wherein said computation component comprises a microcontroller.

13. The method of claim 11, wherein said actuation component comprises a servo or motor structure.

14. The method of claim 11, wherein said agents are connected to form a flexible surface, said agents are capable of changing the configuration of the surface via actuation.

15. The method of claim 11, wherein each of said agents has a unique identity.

16. The method of claim 11, wherein said sensing component comprises a pressure sensor or tilt sensor.

17. The method of claim 11, wherein each of surface groups is specified with a sensory state respective to a desired shape.

18. The method of claim 14, wherein each agent coordinates with other agents to perform simultaneous actuation to achieve a desired task or shape change.

19. The method of claim 14, wherein each agent provides sensory information to their neighboring agents, each of said agents collect the information and computes a feedback.

20. The method of claim 19, wherein each agent utilizes said feedback to perform actuation, the direction of actuation is toward the direction of achieving a desired state with each neighbor.
